(19) United States
(12) Patent Application Publication
(10) Pub. No.: US 2022/0406313 A1
(43) Pub. Date: Dec. 22, 2022

(54) SYSTEMS AND METHODS FOR ENABLING VOICE-BASED TRANSACTIONS AND VOICE-BASED COMMANDS

(71) Applicant: LISNR, Cincinnati, OH (US)

(72) Inventor: Srivathsan Narasimhan, Saratoga, CA (US)

(21) Appl. No.: 17/808,224

(22) Filed: Jun. 22, 2022

Related U.S. Application Data
(60) Provisional application No. 63/213,438, filed on Jun. 22, 2021.

(51) Int. Cl. G10L 17/20; G10L 17/22; G10L 25/84; G10L 17/02; G10L 17/06

(52) U.S. Cl. CPC G10L 17/20; G10L 17/22; G10L 25/84; G10L 17/02; G10L 17/06

(57) ABSTRACT

Aspects of the present disclosure involve processing audio signals to determine the presence and proximity of a user to a computing device, such as a voice-controlled computing device located within an environment. When the proximity of the user in comparison to the computing device is within an acceptable threshold, a voice command is detected that is associated with the user of a plurality of users located in the environment. In some instances, a device command is generated based on the voice command. The device command is executed, for example, at the computing device.

### CROSS-REFERENCE TO RELATED APPLICATIONS

The present application claims priority to U.S. Provisional Patent Application No. 63/213,438, filed on Jun. 22, 2021, the disclosure of which is incorporated herein by reference for all purposes.

### BACKGROUND

Data often needs to be transmitted between computing devices without connecting both devices to the same computing network. For example, in certain applications, a computing network may not exist near the computing devices, or it may be too cumbersome (e.g., may take too long) to connect one or both of the computing devices to a nearby computing network. Therefore, data may be transmitted directly from one computing device to another.

In some instances, it may be desirable to transmit data between computing devices without connecting both devices to the same computing network to enable identification of a person, or group of persons located in particular proximity to one or more of the devices.

### SUMMARY

The present disclosure presents new and innovative systems and methods for processing voice-based transactions and commands. In a first aspect, a method is provided that includes obtaining an audio signal at a first computing device located within an environment and, based on the audio signal, determining a presence of a user from a plurality of users located in the environment and determining that the user is within a threshold distance from the first computing device. The method also includes determining, in response to determining that the user is within the threshold distance, a voice command associated with the user and, based on the voice command, generating a device command. The method further includes causing the device command to be executed within the environment.

In a second aspect according to the first aspect, the audio signal is obtained at the computing device in response to the computing device determining that the environment is too noisy to verify a voice of the user.

In a third aspect according to the second aspect, the method further includes, prior to obtaining the audio signal, detecting a voice command from the user, determining a signal-to-noise ratio (SNR) for the voice command within the environment, and determining that the SNR is less than a predetermined threshold. The audio signal may be obtained in response to determining that the SNR is less than the predetermined threshold.

In a fourth aspect according to any of the first through third aspects, the presence of the user is determined based on an audio transmission received from a second computing device associated with the user.

In a fifth aspect according to the fourth aspect, the audio transmission contains a unique identifier associated with the user.

In a sixth aspect according to the fifth aspect, determining the presence of the user further comprises detecting, within the audio signal, a preamble indicating the presence of the audio transmission and identifying, based on the preamble, a payload of the audio transmission. Determining the presence of the user may further include extracting, from the payload, the unique identifier, determining that the unique identifier corresponds to the user, and determining, based on the unique identifier corresponding to the user, that the user is present within the environment.

In a seventh aspect according to any of the fourth through sixth aspects, the audio transmission is transmitted with a predetermined magnitude. Determining that the user is within the threshold distance may also include determining a received magnitude of the audio transmission and determining that the received magnitude exceeds a predetermined threshold.

In an eighth aspect according to any of the first through seventh aspects, determining that the user is within the threshold distance is performed based on the magnitude of a voice command from the user.

In a ninth aspect according to the eighth aspect, determining that the user is within the threshold distance includes detecting a voice command from the user, determining a signal-to-noise ratio (SNR) for the voice command within the environment, and determining that the SNR is greater than a predetermined threshold.

In a tenth aspect according to any of the first through ninth aspects, the voice command comprises voice data and/or text data reflecting a request made by the user within the environment.

In an eleventh aspect according to any of the first through tenth aspects, the device command comprises at least one function that can be executed by the voice-controlled device to fulfill the voice command.

In a twelfth aspect, a system is provided that includes a processor and a memory. The memory stores instructions which, when executed by the processor, cause the processor to obtain an audio signal at a first computing device located within an environment and, based on the audio signal, determine a presence of a user from a plurality of users located in the environment and determine whether the user is within a threshold distance from the first computing device. The instructions may further cause the processor to determine, in response to determining that the user is within the threshold distance, a voice command associated with the user, based on the voice command, generate a device command, and cause the device command to be executed within the environment.

In a thirteenth aspect according to the twelfth aspect, the audio signal is obtained at the computing device in response to the computing device determining that the environment is too noisy to verify a voice of the user.

In a fourteenth aspect according to the thirteenth aspect, the instructions further cause the processor to, prior to obtaining the audio signal, detect a voice command from the user, determine a signal-to-noise ratio (SNR) for the voice command within the environment, and determine that the SNR is less than a predetermined threshold. The audio signal may be obtained in response to determining that the SNR is less than the predetermined threshold.

In a fifteenth aspect according to the twelfth aspect, the presence of the user is determined based on an audio transmission received from a second computing device associated with the user.

In a sixteenth aspect according to the fifteenth aspect, the audio transmission contains a unique identifier associated with the user.

In a seventeenth aspect according to the sixteenth aspect, the instructions further cause the processor to, while determining the presence of the user, detect, within the audio signal, a preamble indicating the presence of the audio transmission, identify, based on the preamble, a payload of the audio transmission, and extract, from the payload, the unique identifier. The instructions may further cause the processor to determine that the unique identifier corresponds to the user and determine, based on the unique identifier corresponding to the user, that the user is present within the environment.

In an eighteenth aspect according to any of the fifteenth through seventeenth aspects, the audio transmission is transmitted with a predetermined magnitude. The instructions may further cause the processor, while determining that the user is within the threshold distance, to determine a received magnitude of the audio transmission and determine that the received magnitude exceeds a predetermined threshold.

In a nineteenth aspect according to any of the twelfth through nineteenth aspects, determining that the user is within the threshold distance is performed based on the magnitude of a voice command from the user.

In a twentieth aspect according to the nineteenth aspect, the instructions further cause the processor to, while determining that the user is within the threshold distance, detect a voice command from the user, determine a signal-to-noise ratio (SNR) for the voice command within the environment, and determine that the SNR is greater than a predetermined threshold.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a computing system according to exemplary embodiments of the present disclosure.

FIG. 2 illustrates an audio transmission, according to an exemplary embodiment of the present disclosure.

FIG. 3 illustrates a computing environment including a voice-controlled device, according to an exemplary embodiment of the present disclosure.

FIG. 4 illustrates a method for executing the presence of users in an environment, according to an exemplary embodiment of the present disclosure.

FIG. 5 illustrates a computing system, according to an exemplary embodiment of the present disclosure.

### DETAILED DESCRIPTION

Aspects of the present disclosure relate to processing audio signals to determine the presence and proximity of a user to a computing device, such as a voice-controlled computing device. When the presence of the user to the computing device is within an acceptable threshold, a voice command associated with the user may be identified and processed to perform functions at the voice-controlled computing device.

Various techniques and systems exist to exchange data between computing devices without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency Identification (RFID), Near Field Communication (NFC), and Wi-Fi® (e.g., direct Wi-Fi links between the computing devices). However, each of these protocols relies on data transmission using electromagnetic waves at various frequencies. Therefore, in certain instances (e.g., ZigBee®, Z-Wave®, RFID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired in order to transmit data according to these wireless communication protocols. Such communicative pairing can be cumbersome and slow, reducing the likelihood that users associated with one or both of the computing devices will utilize the protocols to transmit data.

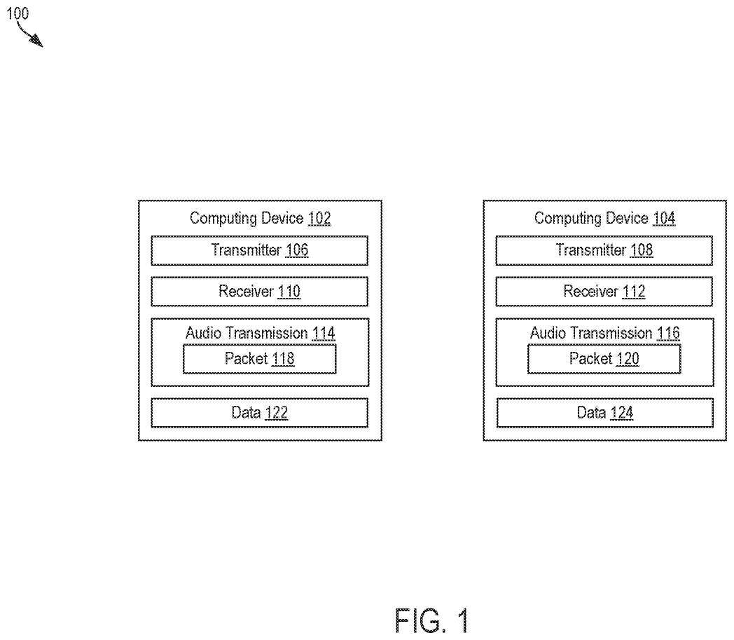

Therefore, there exists a need to wirelessly transmit data in a way that (i) does not require specialized hardware and (ii) does not require communicative pairing prior to data transmission. One solution to this problem is to transmit data using audio transmissions. For example, FIG. 1 illustrates a system 100 according to an exemplary embodiment of the present disclosure. The system 100 includes two computing devices 102, 104 configured to transmit data 122, 124 using audio transmissions 114, 116. In particular, each computing device 102, 104 includes a transmitter 106, 108 and a receiver 110, 112. The transmitters 106, 108 may include any type of device capable of generating audio signals, such as speakers. In certain implementations, the transmitters 106, 108 may be implemented as a speaker built into the computing device 102, 104. For example, one or both of the computing devices may be a smart phone, tablet computer, and/or laptop with a built-in speaker that performs the functions of the transmitter 106, 108. In other implementations, the transmitters 106, 108 may be implemented as a microphone external to the computing device 102, 104. For example, the transmitters 106, 108 may be implemented as one or more speakers externally connected to the computing device 102, 104.

The receivers 110, 112 may include any type of device capable of receiving audio transmissions and converting the audio transmissions into signals (e.g., digital signals) capable of being processed by a processor of the computing device, such as microphones. In other implementations, the receivers 110, 112 may be implemented as a microphone built into the computing device 102, 104. For example, one or both of the computing devices may be a smart phone, tablet computer, and/or laptop with a built-in microphone that performs the functions of the receivers 110, 112. In other implementations, the receivers 110, 112 may be implemented as a microphone external to the computing device 102, 104. For example, the receivers 110, 112 may be implemented as one or more microphones external to the computing device 102, 104 that are communicatively coupled to the computing device 102, 104. In certain implementations, the transmitter 106, 108 and receiver 110, 112 may be implemented as a single device connected to the computing device. For example, the transmitter 106, 108 and receiver 110, 112 may be implemented as a single device containing both a speaker and a microphone that is communicatively coupled to the computing device 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112. In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing devices 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmission 114, 116, the computing devices 102, 104 may modulate the packets 118, 120 onto an audio carrier signal. The computing devices 102, 104 may then transmit the audio transmission 114, 116 via the transmitter 106, 108, which may then be received by the receiver 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Also, because these techniques can utilize conventional computer hardware like speakers and microphones, the computing devices 102, 104 do not require specialized hardware to transmit the data 122, 124.

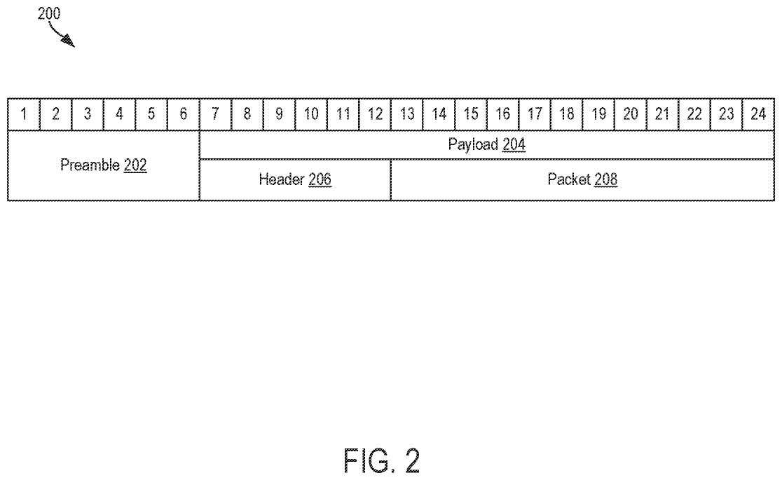

FIG. 2 illustrates an audio transmission 200 according to an exemplary embodiment of the present disclosure. The audio transmission 200 may be used to transmit data from one computing device to another computing device. For example, referring to FIG. 1, the audio transmission 200 may be an example implementation of the audio transmissions 114, 116 generated by the computing devices 102, 104. The audio transmission 200 includes multiple symbols 1-24, which may correspond to discrete time periods within the audio transmission 200. For example, each symbol 1-24 may correspond to 5 ms of the audio transmission 200. In other examples, the symbols 1-24 may correspond to other time periods within the audio transmission 200 (e.g., 1 ms, 10 ms, 20 ms, 40 ms). Each symbol 1-24 may include one or more frequencies used to encode information within the audio transmission 200. For example, the one or more frequencies may be modulated in order to encode information in the audio transmission 200 (e.g., certain frequencies may correspond to certain pieces of information). In another example, the phases of the frequencies may be additionally or alternatively be modulated in order to encode information in the audio transmission 200 (e.g., certain phase differences from a reference signal may correspond to certain pieces of information).

In particular, certain symbols 1-24 may correspond to particular types of information within the audio transmission 200. For example, the symbols 1-6 may correspond to a preamble 202 and symbols 7-24 may correspond to a payload 204. The preamble 202 may contain predetermined frequencies produced at predetermined points of time (e.g., according to a frequency pattern). In certain implementations, the preamble 202 may additionally or alternatively contain frequencies (e.g., a particular predetermined frequency) whose phase differences are altered by predetermined amounts at predetermined points of time (e.g., according to a phase difference pattern). The preamble 202 may be used to identify the audio transmission 200 to a computing device receiving the audio transmission 200. For example, a receiver of the computing device receiving audio transmissions such as the audio transmission 200 may also receive other types of audio data (e.g., audio data from environmental noises and/or audio interference). The preamble 202 may therefore be configured to identify audio data corresponding to the audio transmission 200 when received by the receiver of the computing device. In particular, the computing device may be configured to analyze incoming audio data from the receiver and to disregard audio data that does not include the preamble 202. Upon detecting the preamble 202, the computing device may begin receiving and processing the audio transmission 200. The preamble may also be used to align processing of the audio transmission 200 with the symbols 1-24 of the audio transmission 200. In particular, by indicating the beginning of the audio transmission 200, the preamble 202 may enable the computing device receiving the audio transmission 200 to properly align its processing of the audio transmission with the symbols 1-24.

The payload 204 may include the data intended for transmission, along with other information enabling proper processing of the data intended for transmission. In particular, the packets 208 may contain data desired for transmission by the computing device generating the audio transmission 200. For example, and referring to FIG. 1, the packet 208 may correspond to the packets 118, 120 which may contain all or part of the data 122, 124. The header 206 may include additional information for relevant processing of data contained within the packet 208. For example, the header 206 may include routing information for a final destination of the data (e.g., a server external to the computing device receiving the audio transmission 200). The header 206 may also indicate an originating source of the data (e.g., an identifier of the computing device transmitting the audio transmission 200 and/or a user associated with the computing device transmitting the audio transmission 200).

The preamble 202 and the payload 204 may be modulated to form the audio transmission 200 using similar encoding strategies (e.g., similar encoding frequencies). Accordingly, the preamble 202 and the payload 204 may be susceptible to similar types of interference (e.g., similar types of frequency-dependent attenuation and/or similar types of frequency-dependent delays). Proper extraction of the payload 204 from the audio transmission 200 may rely on proper demodulation of the payload 204 from an audio carrier signal. Therefore, to accurately receive the payload 204, the computing device receiving the audio transmission 200 must account for the interference.

Symbols 1-24 and their configuration depicted in FIG. 2 are merely exemplary. It should be understood that certain implementations of the audio transmission 200 may use more or fewer symbols, and that one or more of the preamble 202, the payload 204, the header 206, and/or the packet 208 may use more or fewer symbols than those depicted and may be arranged in a different order or configuration within the audio transmission 200.

The techniques described above may be used to improve the provisioning of software services that require users to be located near one another, and/or connecting and communication between computing devices in close proximity to one another. For example, many computing-device based activities that were exclusively being performed in computing network-enabled spaces, such as an office or home, are now being performed in computing-network sensitive areas and acoustically variable situations, such as in a car, street, store, restaurant and/or the like. These locations may have limited computing network capabilities and thus may be unable to rely on typical, network-dependent techniques for user location verification. Additionally or alternatively, a substantial amount of voice communication is taking place in environments with limited network connectivity and where users are surrounded by other people, which may present complex and potentially confusing noise/audio content.

Aspects of the present disclosure addresses these technical problems, among others, by transmitting identifying information between computing devices using audio transmissions. Due to physical constraints on the range of audio transmissions, audio transmissions may typically only be successfully transmitted between computing devices that are located near one another (e.g., within several hundred feet). Therefore, if a computing device receives an audio transmission from another computing device, the two computing devices are likely located near one another (i.e., within a certain proximity with one another). The computing device receiving the audio transmission can then use the received identifying information to potentially identify the presence of a user (e.g., identified from a plurality of users) associated with the other computing device. Once the presence and proximity of the user is established, any human speech (e.g., voice commands or voice data) detected from the audio signal or other audio signals at the computing device may be used to execute one or more functions at the computing device, predict relevant content for presentation to the identified user, and/or the like.

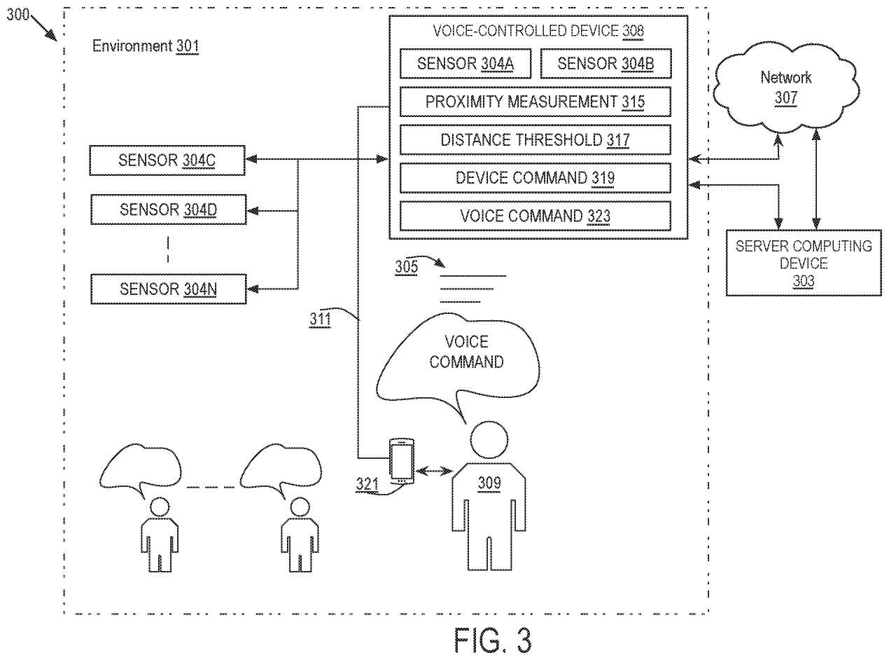

FIG. 3 illustrates an example computing system 300 for determining the presence and proximity of a user at a computing device, such as a voice-controlled device, according to aspects of the present disclosure. As illustrated in the embodiment of FIG. 3, the computing system 300 may include an environment 301 (e.g., a restaurant, store, facility, venue, etc.) containing a voice-controlled device 308 and/or one or more sensors 304A-304N (e.g., microphones), which may be internal and/or external to the voice-controlled device 308. Stated differently, in some instances, the voice-controlled device 308 may include one or more of the sensors, such as sensors 304A, 304B as illustrated. The sensors 304A-304N may receive a signal 305 (e.g., voice data, audio data, and/or the like) from one or more users, such as user 309. Additionally or alternatively, the sensors 304A-304N may receive signals from one or more computing devices located within the environment 301, such as the mobile computing device 321.

The voice-controlled device 308 may typically be configured to receive audio signals containing voice data from users 309 within the environment 301. In response, the voice-controlled device 308 may be configured to identify one or more corresponding voice commands contained within the voice data and to execute device commands associated with the identified voice commands. However, certain voice commands may require authenticating corresponding users (e.g., picking up goods ordered online, ordering food at a restaurant). In such instances, the voice-controlled device 308 may attempt to verify corresponding users based on voice data (e.g., using one or more voice identification protocols). However, in certain circumstances, multiple users may be located within the same environment 301, and receiving voice data from the multiple users may make it difficult to uniquely identify a requesting user 309 based solely on their voice data.

Accordingly, in such instances, the voice-controlled device 308 may be configured to determine the presence of the user 309 using other means. For example, to determine the presence of a user 309 in the environment 301, the voice-controlled device 308 may receive and process audio transmissions identifying computing devices located near the voice-controlled device 308. For example, the voice-controlled device 308 may receive an audio transmission 311, from another computing device, such as a mobile device 321 corresponding to the user 308. In some instances, the audio transmission 311 may include a unique identifier that uniquely corresponds to the mobile computing device 321 from which the audio transmission 311 was received and/or uniquely corresponds to a user associated with the mobile computing device 321. For example, the unique identifier may include an alphanumeric identifier (e.g., a universally unique identifier (UUID)), a hash, a device identifier, a MAC address, a username, and/or any other type of identifier uniquely associated with the user, the user's account, and/or a computing device associated with the user.

Upon receiving the audio transmission 311, the voice-controlled device 308 may transmit the unique identifier to a server computing device 303. Based on the unique identifier, the server computing device 303 may determine that the mobile computing device 321 is associated with the user 308, thereby uniquely identifying the user 309 and uniquely identifying the presence of the user 309. The server computing device 303 may store unique identifiers in association with unique users in a database. In various implementations, the server computing device 303 may be implemented as a local server and/or as a remote server. For example, the server computing device 303 may operate as a local server and may be implemented by a computing device connected to a local network of the environment 301 (e.g., located within the same building and/or the same facility as the environment 301). In additional or alternative implementations, the server computing device 303 may be implemented as a remote or centralized server device accessible via a global network, such as the Internet. In various implementations, the network 308 may be implemented to include one or both of a local network and a global network. In various implementations, unique identifiers may be individually generated for each user and/or each user may have multiple associated identifiers. For example, a unique identifier may be generated for each computing device connected with the user's account and/or for each command and/or order received from the user.

In some instances, in addition to determining the presence of the user 309, the system may determine a proximity measurement 315 indicating a distance of the user 309 in comparison (e.g., to or from) with the voice-controlled device 308. In one example, the sensors 304A-304N may obtain one or more proximity measurements associated with the user 309. In the scenario in which the sensors are each a microphone, a microphone can be used to capture signal strength measurements (e.g., amplitudes of audio signals received that contain audio transmissions from the mobile computing device 321) and determine a proximity of the user 309 to the voice-controlled device 308. For instance, audio transmissions may be transmitted with a predetermined magnitude. In such instances, a received magnitude of the audio transmission may be determined by the voice-controlled device 308 and compared to the predetermined magnitude (e.g., a corresponding predetermined threshold determined based on the predetermined magnitude). If the receive magnitude is greater than a predetermined threshold (e.g., a distance threshold 317), the proximity measurement 315 may be determined to indicate that user 309 is located within the environment 301. If the received magnitude is less than the predetermined threshold, the proximity measurement 315 may be determined to indicate that the user 309 is not located within the environment 301. In additional or alternative implementations, the sensors 304A-304N may include multiple microphones. In such a scenario, when a user 309 speaks, each microphone may measure a signal strength of the voice data, and the multiple measured signal strengths can be used to determine if the user 309 is within a threshold distance or certain distance from the voice-controlled device 308. For example, a signal-to-noise ratio may be calculated for the voice data and compared to a predetermined threshold to determine the proximity measurement 315. Various implementations are discussed in greater detail below. In certain instances, the voice-controlled device 308 may compare the proximity measurement 315 to the distance threshold 317 and determine whether the user 309 is close enough to the voice-controlled device 308 to begin executing voice commands from the user 309.

Based on the determined presence and proximity of the user 309 to the voice-controlled device 308, the system may identify voice commands from the identified user, generate device commands for the voice-controlled device 308, and perform the device commands. Voice commands 323 may include one or more requests and/or commands as reflected in voice data received from a user 309. In certain implementations, the voice commands 323 may be stored as the voice data received from the user 309 (e.g., raw voice data from the environment 301, processed voice data that filters out environmental noise to extract the user's 309 voice). In additional or alternative implementations, the voice commands 323 may be stored as text reflecting the words spoken by the user 309. Device commands 319 may include one or more computer functions and/or computer programs executable by voice-controlled device 308. In various implementations, the device commands 319 main include one or more function calls corresponding to different types of voice commands 323. Device commands 319 can be performed in response to the determined proximity of the user 309 being above, below, and/or within an acceptable threshold value (e.g., indicating that the user is within an acceptable distance of the voice-controlled device 308). For instance, the voice-controlled device 308 may perform the device command in response to determining the user 309 is within the threshold proximity to the voice-controlled device 308. Alternatively, the device command can be denied (e.g., not performed) in response to identifying the user 309 is not within an acceptable distance of the voice-controlled device 308.

The voice-controlled device 308 is communicatively coupled to the server computing device 303 by the network 307. The network 307 may be implemented by one or more local networks (e.g., local area networks) and/or by one or more non-local networks (e.g., the internet). The voice-controlled device 308 and the server computing device 303 may connect to the network 307 using one or more wired or wireless communication interfaces. For example, the voice-controlled device 308 and the server computing device 303 may connect to the network 307 using Wi-Fi®, Ethernet, Bluetooth®, WiMAX®, and/or other data connection interfaces. In certain instances, the server computing device 303 and the voice-controlled device 308 may connect to different types of networks and/or may use different types of communication interfaces. One or both of the voice-controlled device 308 and/or the server computing device 303 may be implemented by a computing system. For example, although not depicted one or both of the voice-controlled device 308 and the server computing device 303 may contain a processor and a memory that implements at least one operational feature. For example, the memory may contain instructions which, when executed by the processor, cause the processor to implement at least one operational feature of the voice-controlled device 308 and/or the server computing device 303. Similarly, the mobile computing device 321 may be implemented by a computing system.

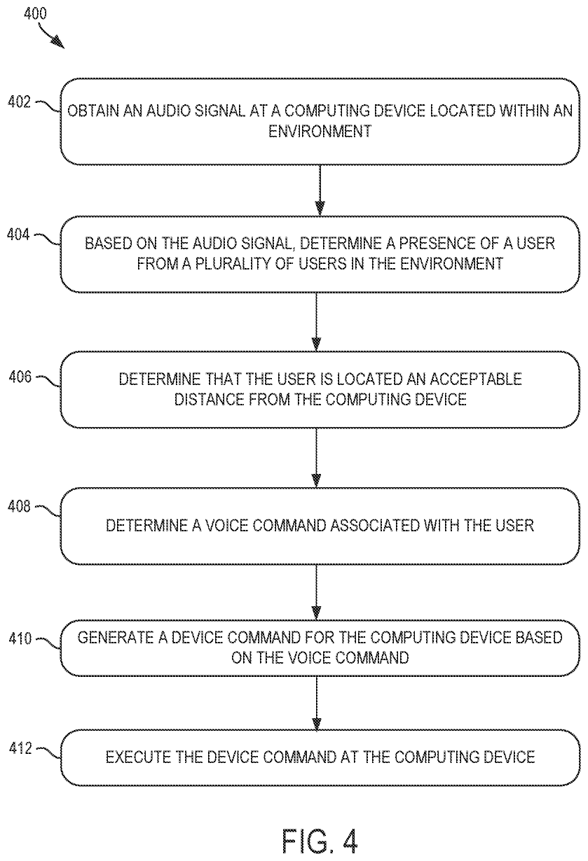

FIG. 4 illustrates an example of a method and/or process 400 for determining the presence and/or proximity of a user at a computing device, such as a voice-controlled device according to one or more embodiments of the present disclosure. The method 400 may be implemented on a computer system, such as the computing system in FIGS. 1, 3, and 5. The method 400 may also be implemented by a set of instructions stored on a computer readable medium that, when executed by a processor, cause the computer system to perform the method. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional.

As illustrated, process 400 begins at block 402, with receiving, detecting, or otherwise obtaining an audio signal at a computing device located within an environment. For example, and with reference to FIG. 3, the voice-controlled device 308 may receive or otherwise detect an audio signal from the mobile device 321 within an environment 301. In particular, the voice-controlled device 308 may include one or more microphones that may receive an audio signal broadcast from the mobile device 321 (e.g., via speakers of the mobile device). The environment 301 may be a public environment such as a restaurant and/or a home environment, in an example. In particular, the environment 301 may contain enough audio activity from sources other than the user 309 (e.g., other individuals, music, vehicles, or any other source of noise) that it may not be possible to verify the user 309 based solely on the contents of audio commands received from the user 309. In certain instances, prior to obtaining the audio signal at black 402, the voice-controlled device 308 may initially determine that authenticating the user 309 is not possible using voice data received within the environment 301. For example, the voice-controlled device 308 may determine a signal to noise ratio (SNR) for the voice of data within the environment 301. The voice-controlled device 308 may compare the SNR to a predetermined threshold. If the SNR is less than the predetermined threshold, the voice-controlled device 308 may determine that authenticating the user 309 using voice data is not possible and may, in response, proceed with block 402. If the SNR is greater than the predetermined threshold, the voice-controlled device 308 may proceed with authenticating the user based on voice data using one or more voice authentication protocols. Additionally or alternatively to calculating an SNR for the received voice data, the voice-controlled device 308 may attempt to perform voice authentication using the voice data (e.g., based on one more voice authentication protocols). If a voice authentication operation using the voice data fails, the voice-controlled device 308 may proceed with block 402.

In certain instances, the mobile computing device 321 may transmit the audio signal, which may contain an audio transmission. In certain implementations, the mobile computing device 321 may be configured to automatically transmit the audio transmission. For example, the mobile computing device 321 may transmit an audio transmission after detecting the voice-controlled device 308 (e.g., a beacon audio signal transmitted by the voice-controlled device 308, after detecting that the mobile computing device 321 has arrived at the environment 301 (e.g., based on GPS data)). In additional or alternative implementations, the mobile computing device 321 may transmit the audio transmission in response to a request from the voice-controlled device 308. For example, the voice-controlled device 308 may transmit a request (e.g., via the network 307, via a separate audio transmission) to the mobile computing device 321 for the mobile computing device 321 to transmit the audio transmission.

At block 404, a presence of a user from a set of users in the environment is determined. For example, and with reference to FIG. 3, the voice-controlled device 308 may process the audio signal to obtain a unique identifier and determine that the unique identifier corresponds to the user 309. In particular, the voice-controlled device 308 may receive an audio transmission containing a unique identifier from a mobile computing device 321 associated with the user 309. The voice-controlled device 308 may then extract the unique identifier from the audio transmission. For example, the voice-controlled device 308 may detect, within the audio signal, a preamble 202 (e.g., a predetermined audio signal) indicating the presence of the audio transmission. In response, voice-controlled device 308 may identify a payload 204 of the audio transmission and may extract the unique identifier from the payload 204. In particular, the unique identifier may be contained within a packet 208 of the payload 204, and the voice-controlled device 308 may be configured to extract the packet 208 and the unique identifier contained within from the portion of the audio signal corresponding to the audio transmission. The voice-controlled device 308 may then compare the unique identifier to other, known unique identifiers (e.g., contained within the server computing device 303). The voice-controlled device may, upon determining that the received unique identifier corresponds to the user 309, determine that the user 309 is present within the environment 301.

At block 406, it is determined whether the user 309 is located at an acceptable distance from the computing device. In one specific example, the voice-controlled device 308 may obtain a proximity measurement 315 indicating the proximity of the user in comparison to a voice-controlled device 308 (i.e., an approximate physical distance between the user and the voice-controlled device 308). One or more sensors may be used to detect the proximity of the user in comparison to the voice-controlled device by taking or otherwise generating a measurement indicative of a distance between the user and the voice-controlled device. For example, as explained above, the user's 309 proximity may be determined based on one or more of (i) an amplitude of an audio transmission containing a unique identifier that is received from a computing device 321 associated with the user 309 and/or (ii) an amplitude of the voice command received from the user 309.

At block 408, when the user 309 is located an acceptable distance from the computing device (i.e., satisfies a distance threshold or proximity threshold), a voice command associated with the user is identified. In one specific example, if the voice-controlled device 308 determines that the proximity measurement 315 indicates a distance less than or equal to a distance threshold 317, the voice-controlled device 308 may identify a voice command 323 associated with the user 309. For example, the audio signal may be received in response to a request sent by the voice-controlled device 308 after receiving a voice command 323 that requires authentication. The voice-controlled device 308 may identify the voice command 323 as the voice command that triggered the request.

At block 410, a device command is generated based on the voice command. In one example, the voice command may be processed using a speech recognition engine to convert the voice command to a device command executable by the voice-controlled device 308 or another computing device. At block 412, the device command may instruct the voice-controlled device 308 (or another computing device) to perform a function and such function may be executed. In some instances, the device command may be performed only if the identified user is within the threshold distance to the voice-controlled device.

The method 400 accordingly improves the provisioning of proximity-based, voice-controlled services. In particular, the method 400 improves the ability for voice-controlled computing devices to authenticate users in noisy environments. For example, if a user is attempting to authenticate with a voice-controlled computing device and the voice-controlled computing device determines that a surrounding audio environment is too noisy, the techniques discussed above enable the voice-controlled computing environment to authenticate the user without relying on voice authentication within the noisy environment. In particular, as explained above, audio transmissions may be transmitted between mobile computing devices and voice-controlled computing device 308 at audio frequencies outside the range of human hearing and speaking (e.g., above 18 kHz). Accordingly, even if an environment is noisy, such noises can be filtered out by the voice-controlled computing device while still allowing the voice-controlled computing device to extract the audio transmission and the unique identifier that it contains. Furthermore, these techniques do not rely on communicative coupling between a user's computing device and the voice-controlled device, facilitating faster and simpler communication from a user's perspective. Lastly, these techniques do not rely on network communications and accordingly may be more successful in situations with limited or congested network activity. Thus, the method 400 improves the ability and robustness of computing devices to authenticate for the purposes of provisioning voice-controlled services.

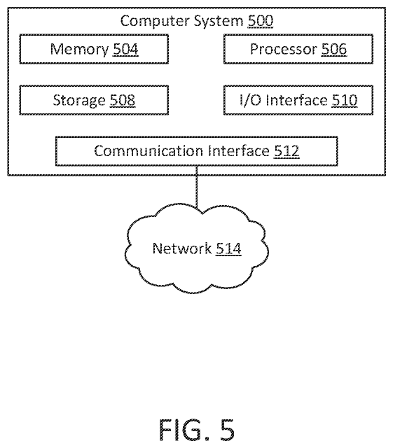

FIG. 5 illustrates an example computer system 500 that may be utilized to implement one or more of the devices and/or components of FIGS. 1 and 3. For example, one or more of the computing devices 102, 104, the voice-controlled device 308, the mobile computing device 321, and/or the server computing device 303 may be implemented by one or more computer systems 500. In particular embodiments, one or more computer systems 500 perform one or more steps of one or more methods described or illustrated herein. In particular embodiments, one or more computer systems 500 provide the functionalities described or illustrated herein. In particular embodiments, software running on one or more computer systems 500 performs one or more steps of one or more methods described or illustrated herein or provides the functionalities described or illustrated herein. For example, one or more of the example computer systems 500 may be used to implement all or part of the method 400. Particular embodiments include one or more portions of one or more computer systems 500. Herein, a reference to a computer system may encompass a computing device, and vice versa, where appropriate. Moreover, a reference to a computer system may encompass one or more computer systems, where appropriate.

This disclosure contemplates any suitable number of computer systems 500. This disclosure contemplates the computer system 500 taking any suitable physical form. As example and not by way of limitation, the computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example, and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 506, memory 504, storage 508, an input/output (I/O) interface 530, and a communication interface 532. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 506 includes hardware for executing instructions, such as those making up a computer program. As an example, and not by way of limitation, to execute instructions, the processor 506 may retrieve (or fetch) the instructions from an internal register, an internal cache, memory 504, or storage 508; decode and execute the instructions; and then write one or more results to an internal register, internal cache, memory 504, or storage 508. In particular embodiments, the processor 506 may include one or more internal caches for data, instructions, or addresses. This disclosure contemplates the processor 506 including any suitable number of any suitable internal caches, where appropriate. As an example, and not by way of limitation, the processor 506 may include one or more instruction caches, one or more data caches, and one or more translation lookaside buffers (TLBs). Instructions in the instruction caches may be copies of instructions in memory 504 or storage 508, and the instruction caches may speed up retrieval of those instructions by the processor 506. Data in the data caches may be copies of data in memory 504 or storage 508 that are to be operated on by computer instructions; the results of previous instructions executed by the processor 506 that are accessible to subsequent instructions or for writing to memory 504 or storage 508; or any other suitable data. The data caches may speed up read or write operations by the processor 506. The TLBs may speed up virtual-address translation for the processor 506. In particular embodiments, processor 506 may include one or more internal registers for data, instructions, or addresses. This disclosure contemplates the processor 506 including any suitable number of any suitable internal registers, where appropriate. Where appropriate, the processor 506 may include one or more arithmetic logic units (ALUs), be a multi-core processor, or include one or more processors 502. Although this disclosure describes and illustrates a particular processor, this disclosure contemplates any suitable processor.

In particular embodiments, the memory 504 includes main memory for storing instructions for the processor 506 to execute or data for processor 506 to operate on. As an example, and not by way of limitation, computer system 500 may load instructions from storage 508 or another source (such as another computer system 500) to the memory 504. The processor 506 may then load the instructions from the memory 504 to an internal register or internal cache. To execute the instructions, the processor 506 may retrieve the instructions from the internal register or internal cache and decode them. During or after execution of the instructions, the processor 506 may write one or more results (which may be intermediate or final results) to the internal register or internal cache. The processor 506 may then write one or more of those results to the memory 504. In particular embodiments, the processor 506 executes only instructions in one or more internal registers or internal caches or in memory 504 (as opposed to storage 508 or elsewhere) and operates only on data in one or more internal registers or internal caches or in memory 504 (as opposed to storage 508 or elsewhere). One or more memory buses (which may each include an address bus and a data bus) may couple the processor 506 to the memory 504. The bus may include one or more memory buses, as described in further detail below. In particular embodiments, one or more memory management units (MMUs) reside between the processor 506 and memory 504 and facilitate accesses to the memory 504 requested by the processor 506. In particular embodiments, the memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 804, where appropriate. Although this disclosure describes and illustrates particular memory implementations, this disclosure contemplates any suitable memory implementation.

In particular embodiments, the storage 508 includes mass storage for data or instructions. As an example, and not by way of limitation, the storage 508 may include a hard disk drive (HDD), a floppy disk drive, flash memory, an optical disc, a magneto-optical disc, magnetic tape, or a Universal Serial Bus (USB) drive or a combination of two or more of these. The storage 508 may include removable or non-removable (or fixed) media, where appropriate. The storage 508 may be internal or external to computer system 500, where appropriate. In particular embodiments, the storage 508 is non-volatile, solid-state memory. In particular embodiments, the storage 508 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 508 taking any suitable physical form. The storage 508 may include one or more storage control units facilitating communication between processor 506 and storage 508, where appropriate. Where appropriate, the storage 508 may include one or more storages 508. Although this disclosure describes and illustrates particular storage, this disclosure contemplates any suitable storage.

In particular embodiments, the I/O Interface 530 includes hardware, software, or both, providing one or more interfaces for communication between computer system 500 and one or more I/O devices. The computer system 500 may include one or more of these I/O devices, where appropriate. One or more of these I/O devices may enable communication between a person and computer system 500. As an example, and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 530 may include one or more device or software drivers enabling processor 506 to drive one or more of these I/O devices. The I/O interface 530 may include one or more I/O interfaces 530, where appropriate. Although this disclosure describes and illustrates a particular I/O interface, this disclosure contemplates any suitable I/O interface or combination of I/O interfaces.

In particular embodiments, communication interface 532 includes hardware, software, or both providing one or more interfaces for communication (such as, for example, packet-based communication) between computer system 500 and one or more other computer systems 500 or one or more networks 534. As an example, and not by way of limitation, communication interface 532 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 534 and any suitable communication interface 532 for it. As an example, and not by way of limitation, the network 534 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 500 may include any suitable communication interface 532 for any of these networks, where appropriate. Communication interface 532 may include one or more communication interfaces 532, where appropriate. Although this disclosure describes and illustrates a particular communication interface implementation, this disclosure contemplates any suitable communication interface implementation.

The computer system 500 may also include a bus. The bus may include hardware, software, or both and may communicatively couple the components of the computer system 500 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
obtaining an audio signal at a first computing device located within an environment;
based on the audio signal, determining a presence of a user from a plurality of users located in the environment;
based on the audio signal, determining that the user is within a threshold distance from the first computing device; and
determining, in response to determining that the user is within the threshold distance, a voice command associated with the user;
based on the voice command, generating a device command; and
causing the device command to be executed within the environment.

2. The method of claim 1, wherein the audio signal is obtained at the computing device in response to the computing device determining that the environment is too noisy to verify a voice of the user.

3. The method of claim 2, further comprising, prior to obtaining the audio signal:
detecting a voice command from the user;
determining a signal-to-noise ratio (SNR) for the voice command within the environment; and
determining that the SNR is less than a predetermined threshold,
wherein the audio signal is obtained in response to determining that the SNR is less than the predetermined threshold.

4. The method of claim 1, wherein the presence of the user is determined based on an audio transmission received from a second computing device associated with the user.

5. The method of claim 4, wherein the audio transmission contains a unique identifier associated with the user.

6. The method of claim 5, wherein determining the presence of the user further comprises:
detecting, within the audio signal, a preamble indicating the presence of the audio transmission;
identifying, based on the preamble, a payload of the audio transmission;
extracting, from the payload, the unique identifier;
determining that the unique identifier corresponds to the user; and
determining, based on the unique identifier corresponding to the user, that the user is present within the environment.

7. The method of claim 4, wherein the audio transmission is transmitted with a predetermined magnitude, and wherein determining that the user is within the threshold distance comprises:
determining a received magnitude of the audio transmission; and
determining that the received magnitude exceeds a predetermined threshold.

8. The method of claim 1, wherein determining that the user is within the threshold distance is performed based on the magnitude of a voice command from the user.

9. The method of claim 8, wherein determining that the user is within the threshold distance comprises:
detecting a voice command from the user;
determining a signal-to-noise ratio (SNR) for the voice command within the environment; and
determining that the SNR is greater than a predetermined threshold.

10. The method of claim 1, wherein the voice command comprises voice data and/or text data reflecting a request made by the user within the environment.

11. The method of claim 1, wherein the device command comprises at least one function that can be executed by the voice-controlled device to fulfill the voice command.

12. A system comprising:
a processor; and
a memory storing instructions which, when executed by the processor, cause the processor to:
obtain an audio signal at a first computing device located within an environment;
based on the audio signal, determine a presence of a user from a plurality of users located in the environment;
based on the audio signal, determine whether the user is within a threshold distance from the first computing device; and
determine, in response to determining that the user is within the threshold distance, a voice command associated with the user;
based on the voice command, generate a device command; and
cause the device command to be executed within the environment.

13. The system of claim 12, wherein the audio signal is obtained at the computing device in response to the computing device determining that the environment is too noisy to verify a voice of the user.

14. The system of claim 13, wherein the instructions further cause the processor to, prior to obtaining the audio signal:
detect a voice command from the user;
determine a signal-to-noise ratio (SNR) for the voice command within the environment; and
determine that the SNR is less than a predetermined threshold,
wherein the audio signal is obtained in response to determining that the SNR is less than the predetermined threshold.

15. The system of claim 12, wherein the presence of the user is determined based on an audio transmission received from a second computing device associated with the user.

16. The system of claim 15, wherein the audio transmission contains a unique identifier associated with the user.

17. The system of claim 16, wherein the instructions further cause the processor to, while determining the presence of the user:
detect, within the audio signal, a preamble indicating the presence of the audio transmission;
identify, based on the preamble, a payload of the audio transmission;
extract, from the payload, the unique identifier;
determine that the unique identifier corresponds to the user; and
determine, based on the unique identifier corresponding to the user, that the user is present within the environment.

18. The system of claim 15, wherein the audio transmission is transmitted with a predetermined magnitude, and wherein the instructions further cause the processor, while determining that the user is within the threshold distance, to:
determine a received magnitude of the audio transmission; and
determine that the received magnitude exceeds a predetermined threshold.

19. The system of claim 12, wherein determining that the user is within the threshold distance is performed based on the magnitude of a voice command from the user.

20. The system of claim 19, wherein the instructions further cause the processor to, while determining that the user is within the threshold distance:
detect a voice command from the user;
determine a signal-to-noise ratio (SNR) for the voice command within the environment; and
determine that the SNR is greater than a predetermined threshold.
